(19) United States
(12) Patent Application Publication
(10) Pub. No.: US 2025/0327321 A1
(43) Pub. Date: Oct. 23, 2025

(54) Access Control Structure

(71) Applicant: Tesseract Ventures, LLC, Overland Park, KS (US)

(72) Inventors: John Boucard, Kansas City, MO (US); Jason Harrell, Tampa, FL (US)

(73) Assignee: Tesseract Ventures, LLC, Overland Park, KS (US)

(21) Appl. No.: 19/176,383

(22) Filed: Apr. 11, 2025

Related U.S. Application Data
(60) Provisional application No. 63/635,942, filed on Apr. 18, 2024.

(51) Int. Cl. E04H 1/12; G07C 9/15; G07C 9/29

(52) U.S. Cl. CPC E04H 1/1205; G07C 9/15; G07C 9/29; E04H 2001/1283

(57) ABSTRACT

An access control system is provided with an access control structure. The access control structure is operable to control access to a zone. A housing forms one or more through paths, and a dividing wall received in the housing is configured such that each through path is non-linear.

### CROSS-REFERENCE TO RELATED APPLICATION

This application claims the benefit of U.S. Provisional Patent Application No. 63/635,942, filed in the U.S. Patent and Trademark Office on Apr. 18, 2024, which is incorporated herein by reference in its entirety for all purposes.

### FIELD

The present disclosure relates generally to an access control system operable to control access to a zone, for example on a jobsite.

### BACKGROUND

Controlling access to a zone (e.g., a jobsite) is essential for safety, security, and efficiency. Implementing measures such as physical barriers, identification systems, visitor management, and surveillance helps ensure that only authorized personnel can enter the site. These measures not only prevent accidents and theft but also demonstrate regulatory compliance and reduce liability.

### BRIEF DESCRIPTION OF THE DRAWINGS

Implementations of the present technology will now be described, by way of example only, with reference to the attached figures, wherein:

FIG. 1A illustrates an access control system;

FIG. 1B illustrates an access control system in an environmental schematic;

FIG. 2A illustrates an access control structure;

FIG. 2B illustrates the access control structure in a deployed configuration;

FIG. 2C illustrates the access control structure with a drone structure in an open configuration;

FIG. 2D illustrates a top cross-sectional view of the access control structure;

FIG. 2E illustrates the access control structure of FIG. 2D, showing assets passing through;

FIG. 2F illustrates an asset entering and a second asset passing through the access control structure;

FIG. 3A illustrates a top view of the access control structure;

FIG. 3B illustrates a front view of the access control structure;

FIG. 4A illustrates the access control system in use;

FIG. 4B illustrates the access control system, with a cross-sectional view of the access control structure; and

FIG. 5 is a schematic diagram of a control system which may be employed as shown in FIGS. 1A-4B.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “about” means reasonably close to the particular value. For example, about does not require the exact measurement specified and can be reasonably close. As used herein, the word “about” can include the exact number. The term “near” as used herein is within a short distance from the particular mentioned object. The term “near” can include abutting as well as relatively small distance beyond abutting. The terms “comprising,” “including” and “having” are used interchangeably in this disclosure. The terms “comprising,” “including” and “having” mean to include, but not necessarily be limited to the things so described.

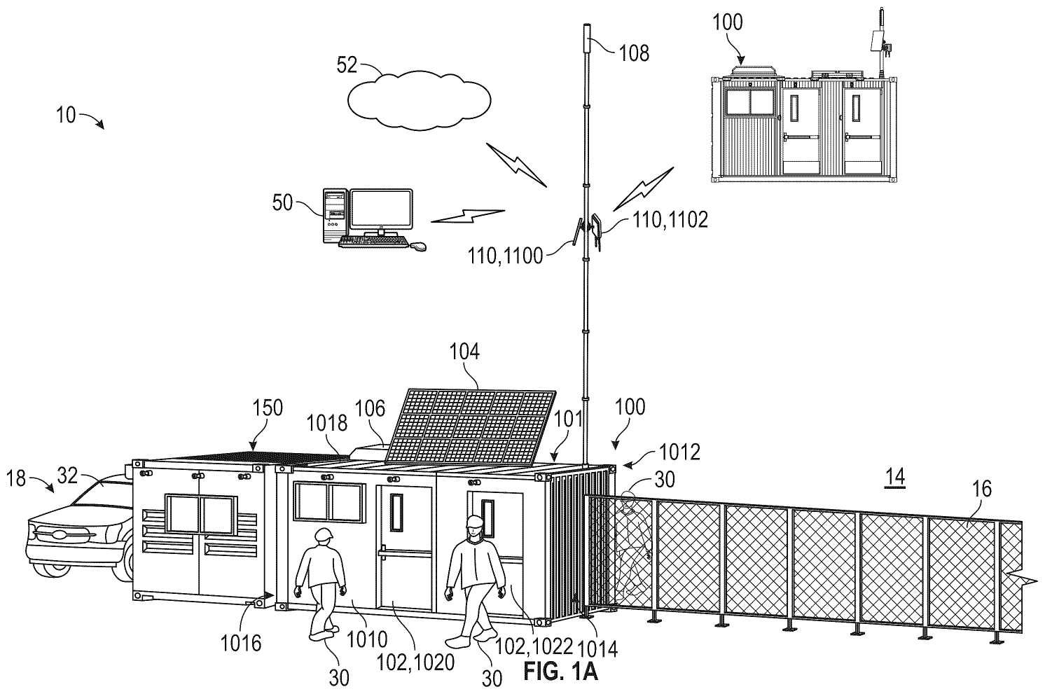

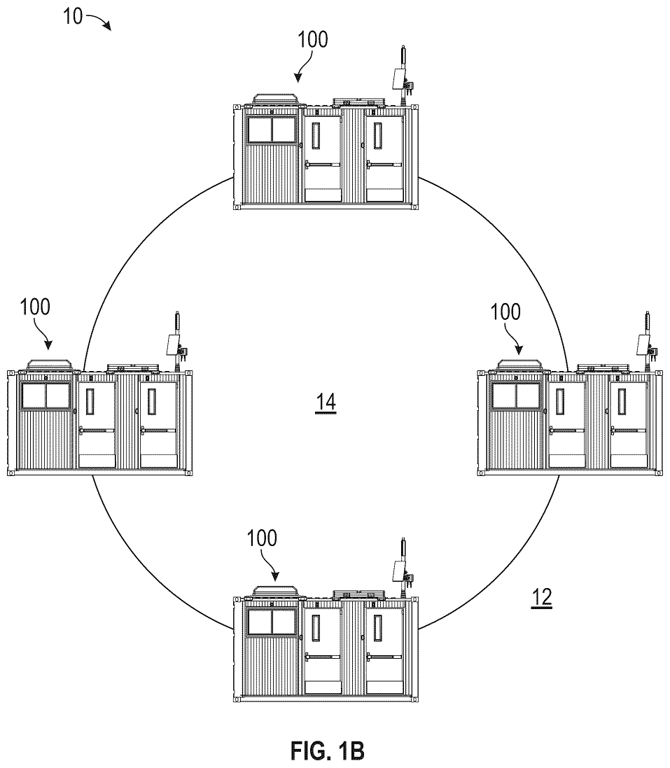

FIGS. 1A and 1B illustrate an example of an access control system 10. The access control system 10 includes one or more access control structures 100 that are operable to control access to the zone 14. The zone 14 can include a jobsite, a private area, a construction site, a military base, or any other suitable zone 14 that requires control of access into and/or out of the zone 14. In some examples, the access control structure 100 can be utilized in conjunction with a blockade 16. The blockade 16 prevents access into the zone 14 from an outside area 12 such that the only passage into the zone 14, and out of the zone 14 is through the access control structure 100. In some examples, the blockade 16 can include a fence. In some examples, the blockade 16 can include a wall. In some examples, the blockade 16 can be coupled with the access control structure 100 such that a person cannot easily pass between the blockade 16 and the access control structure 100.

In at least one example, as illustrated in FIG. 1B, the access control system 10 can include a plurality of access control structures 100. The blockade 16 can connect each of the access control structures 100 such that the access control structures 100 and the blockade 16 form a perimeter around the zone 14. The access control structures 100 can be operable to provide a plurality of access points into and/or out of the zone 14 between the zone 14 and the outside area 12. While FIG. 1B illustrates the perimeter of the zone 14 being circular, the shape can vary as suitable for the zone 14. Also while FIG. 1B illustrates the use of four access control structures 100, in some examples, the access control system 10 can include one, two, three, or more than four access control structures 100 as desired to permit passage between the zone 14 and the outside area 12 without deviating from the scope of the disclosure.

Referring to FIG. 1A, in at least one example, the access control structure 100 can be operable to transmit and/or receive information. For example, the access control structure 100 can be wired and/or wirelessly coupled with a controller 50, a server 52, and/or other access control structures 100. Accordingly, the data regarding assets 30 such as personnel, package(s), equipment, vehicle(s), etc. can be tracked as the assets 30 enter and/or exit the zone 14.

For example, as shown in FIG. 1B, the access control system 10 can include the plurality of access control structures 100. The access control structures 100 can be operable to communicate with each other so that the data regarding movement of the assets 30 within the zone 14 can be tracked as the assets 30 enter and/or leave the zone 14 through the access control structures 100.

In some examples, as will be discussed in further detail below, the access control structures 100 can communicate regarding unauthorized assets (e.g., personnel, package(s), equipment, vehicle(s), etc.). Unauthorized assets can include assets that do not have permission to enter the zone 14 but have passed into the zone 14 from the outside area 12 without permission. For example, an unauthorized asset can include a person that tailgated an authorized asset through an access control structure 100. Another example of an unauthorized asset can include a vehicle 32 that drives into the zone 14 that did not have permission to access the zone 14. The access control structures 100 can identify an unauthorized asset and/or determine that an unauthorized asset is trying to and/or has entered the zone 14. The access control structure 100 can then communicate to the other access control structures 100 regarding the status of the unauthorized asset (e.g., passed into the zone 14, rejected and turned back, etc.), so that the other access control structures 100 can prevent the unauthorized asset from exiting the zone 14 and escaping and/or prevent the unauthorized asset from trying to enter from another access control structure 100. This network of access control structures 100 can improve safety and control of the zone 14.

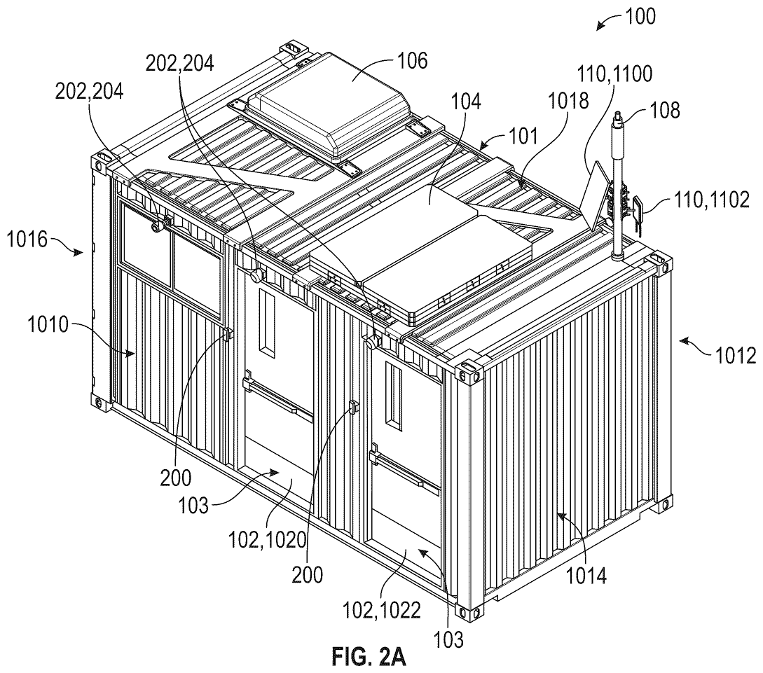

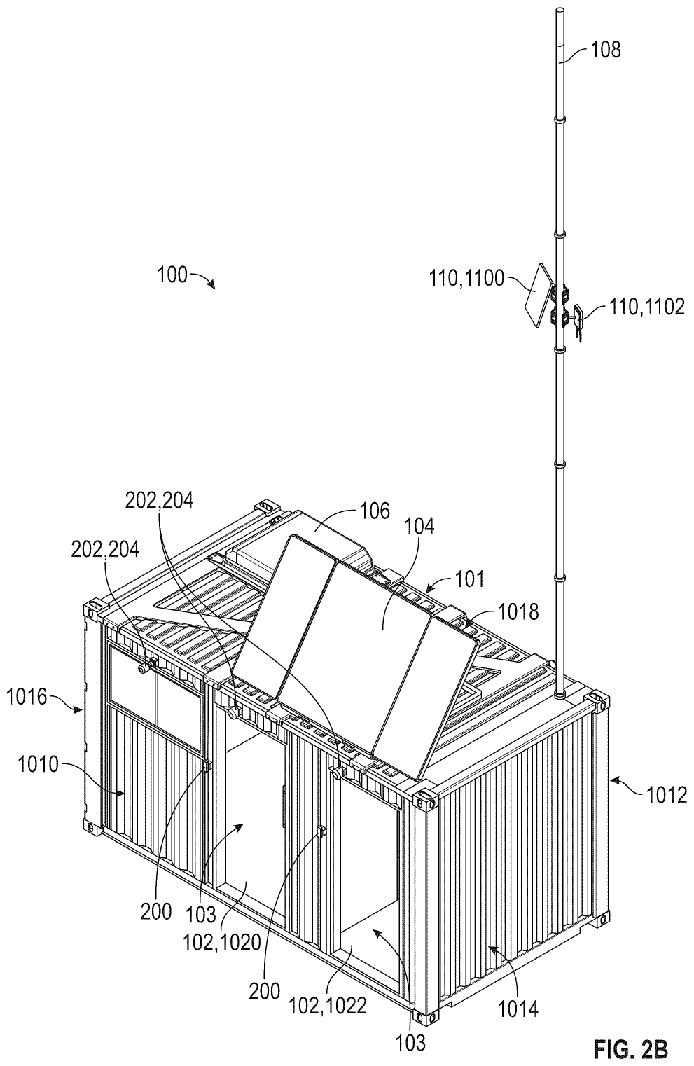

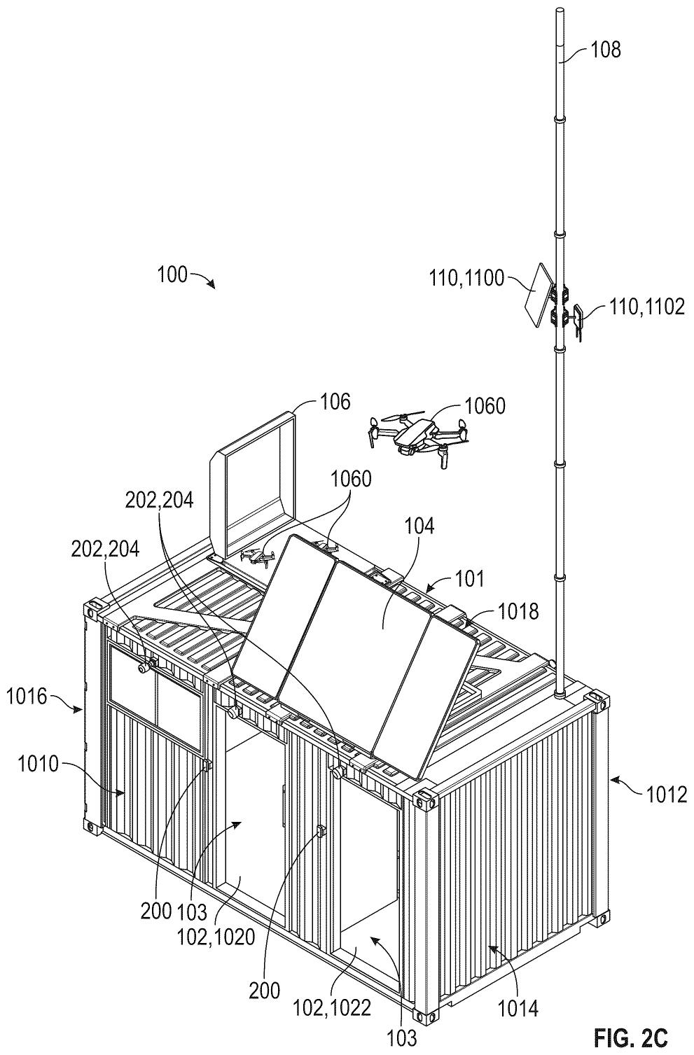

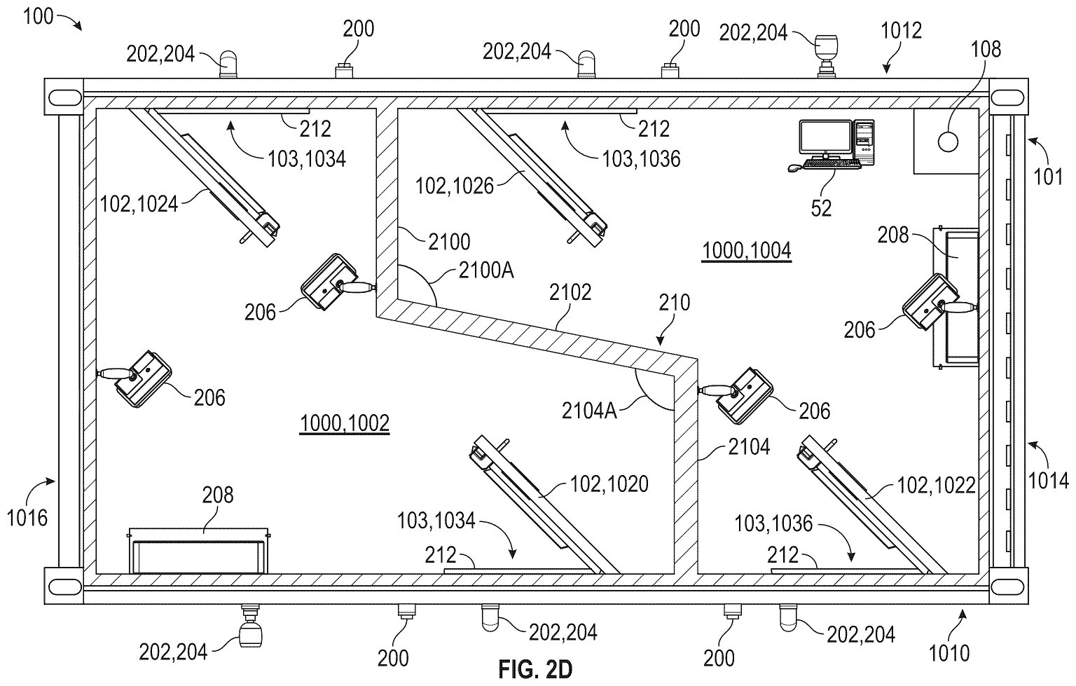

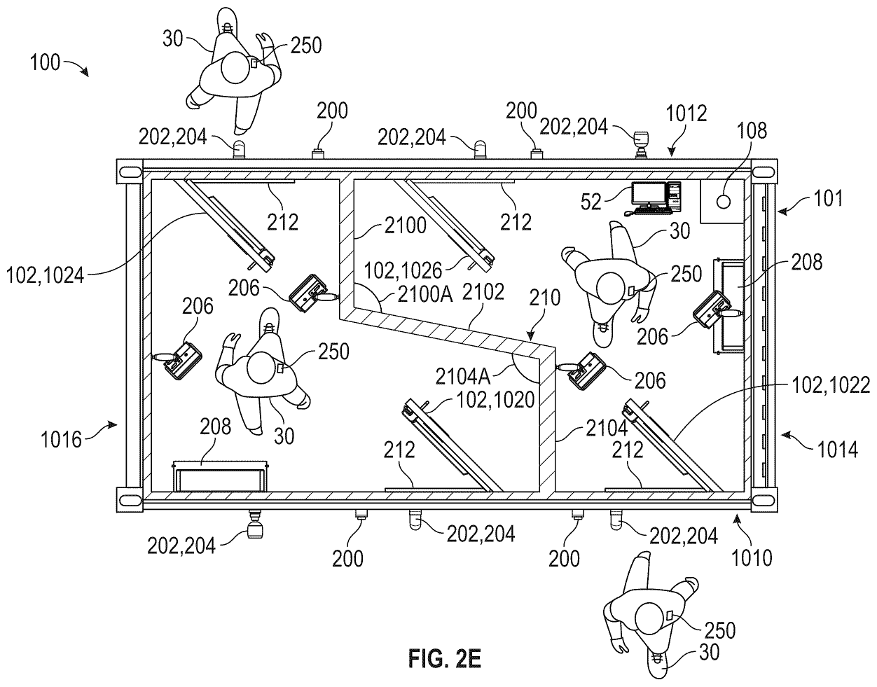

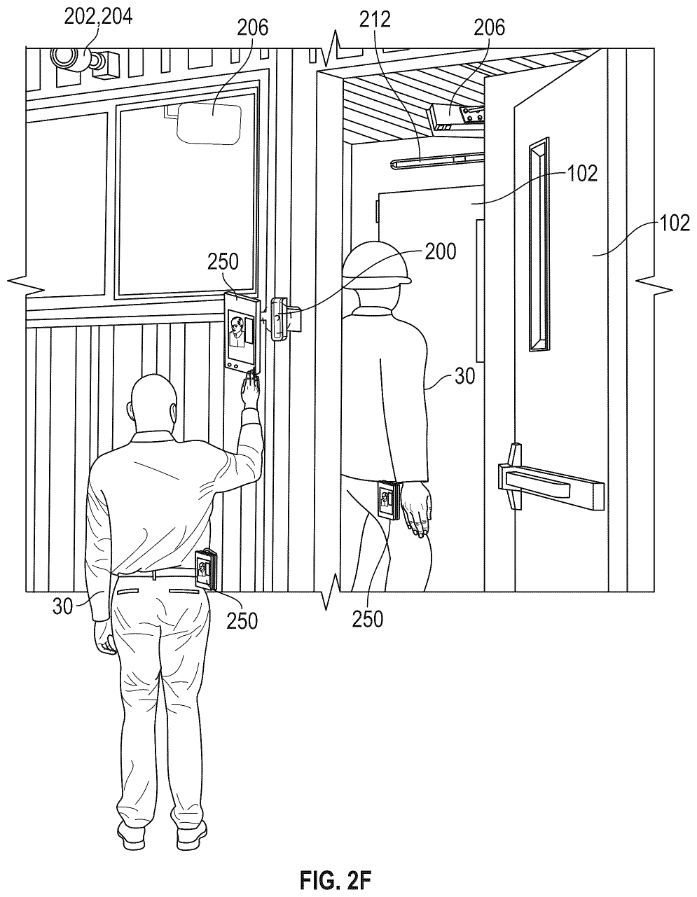

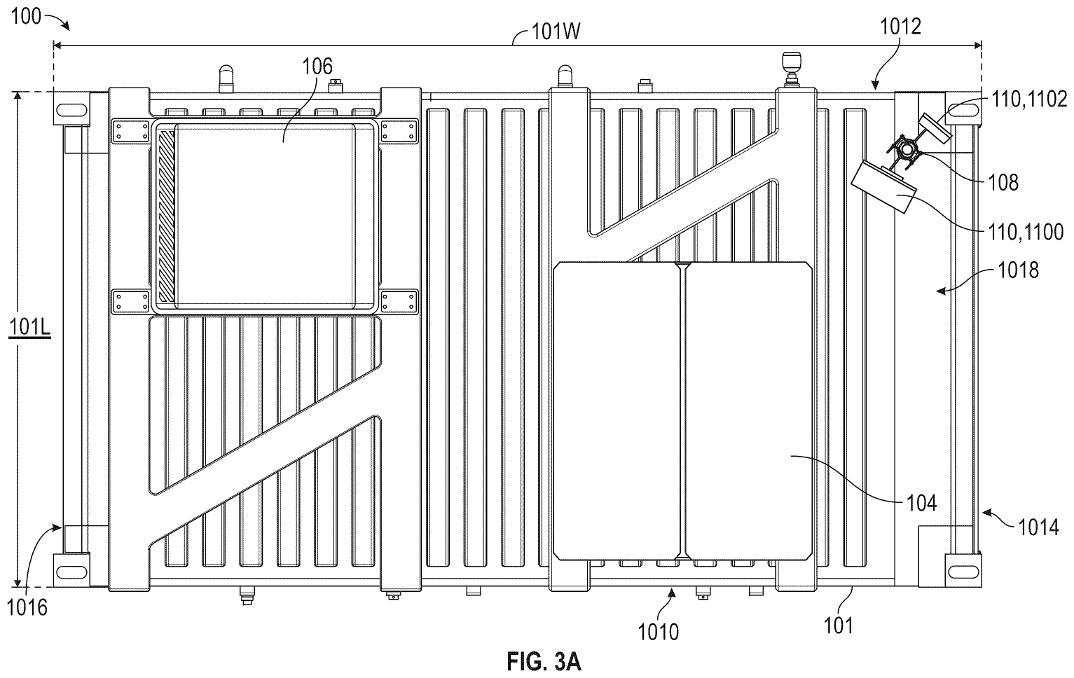

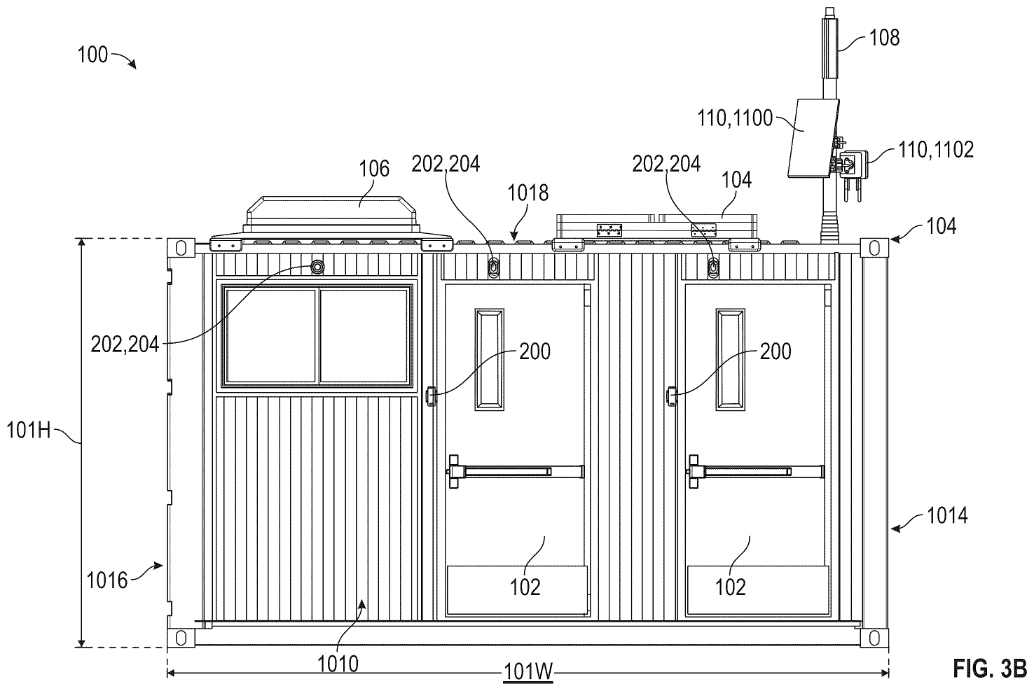

FIGS. 2A-3B illustrate the access control structure 100. The access control structure 100 includes a housing 101. The housing 101 can include a front wall 1010, a rear wall 1012 opposite the front wall 101, and two side walls 1014, 1016 connecting the front wall 1010 and the rear wall 1012. The front wall 1010 and the rear wall 1012 can be substantially parallel to one another. The front wall 1010 can face the outside area 12 while the rear wall 1012 can face the zone 14. The two side walls 1014, 1016 can be disposed at opposing ends of the front wall 1010 and the rear wall 1012. The two side walls 1014, 1016 can be substantially parallel to one another. A top surface 1018 can span the front wall 1010, the rear wall 1012, and the two side walls 1014, 1016 and be opposite the ground. As illustrated herein, the housing 101 can be substantially rectangular in shape. In other examples, the housing 101 can be circular, oval, square, pyramidal, or any other suitable shape without deviating from the scope of the disclosure. The housing 101 is operable to form a structure such that assets 30 can pass therethrough, and also, along with the blockade 16, prevent access into and/or out of the zone 14 otherwise.

Referring to FIGS. 3A and 3B, the housing 101 can have a height 101H spanning from the ground to the top surface 1018. The height 101H can be between about 7 feet and about 11 feet. In some examples, the height 101H can be between about 8 feet and about 10 feet. In some examples, the height 101H can be between about 8 feet and about 9 feet. In some examples, the height 101H can be about 8.5 feet. The housing 101 can have a width 101W spanning between the two side walls 1014, 1016. The width 101W can vary depending on the number of through paths 1000 provided in the housing 101. The width 101W can be between about 4 feet and about 30 feet. In some examples, for a housing 101 with two through paths 1000, the width 101W can be between about 8 feet and about 20 feet. In some examples, the width 101W can be between 12 feet and about 17 feet. In some examples, the width 101W can be about 15 feet. The housing 101 can have a length 101L spanning between the front wall 1010 and the rear wall 1012. The length 101L can be between about 4 feet and about 12 feet. In some examples, the length 101L can be between about 6 feet and about 10 feet. In some examples, the length 101L can be about 8 feet.

The housing 101 is operable to form one or more through paths 1000 through which the asset(s) 30 can pass to gain access to and/or leave the zone 14. The one or more through paths 1000 can include opposing portals 103. While the disclosure may utilize the terms entry and exit, the portal 103 can be utilized for either entry and/or exit depending on which way the asset 30 is passing through the housing 101. For example, an entry portal 103 may refer to when an asset 30 may be entering the housing 101 from the outside area 12 while an exit portal 103 may refer to when an asset 30 is exiting the housing 101 and into the zone 14. However, the entry portal 103 may also refer to when an asset 30 is entering the housing 101 from the zone 104, and the exit portal 103 may refer to when an asset 30 is exiting the housing 101 into the outside area 12.

In at least one example, a blocking structure 102 can be included with one or more of the portals 103. The blocking structures 102 can be operable to transition between a block configuration to prevent passage through the corresponding portal 103 and a pass configuration to permit passage through the corresponding portal 103. For example, the blocking structure 102 can include a door, a turnstile, a gate, and/or a barrier arm. In the example of the blocking structure 102 including a door, as illustrated herein, the block configuration can include locking the door such that the door cannot be opened while the pass configuration can include unlocking the door such that the door can be opened. In some examples, the block configuration of a door can include closing the door while the pass configuration can include opening the door. In the example of the blocking structure 102 including a barrier arm, the block configuration can include lowering the barrier arm to block the path of the portal 103 while the pass configuration can include lifting the barrier arm.

In at least one example, a controller 52 can be communicably coupled with each of the blocking structures 102 provided with the housing 101. The controller 52 can be operable to transition the blocking structure 102 between the block configuration and the pass configuration.

As illustrated herein, the housing 101 can form a first through path 1002 and a second through path 1004. While the disclosure discusses two through paths 1000, one, three, or more through paths 1000 can be incorporated without deviating from the scope of the disclosure. However, in some examples, for example when the access control structure 100 is portable, there is a limit to the number of through paths 1000 that are useful while still providing portability and case of build and/or transfer.

The first through path 1002 can include a first entry portal 1030 and a first exit portal 1034. The first entry portal 1030 can be formed in the front wall 1010, and the first exit portal 1034 can be formed in the rear wall 1012. The second through path 1004 can include a second entry portal 1032 and a second exit portal 1036. The second entry portal 1032 can be formed in the front wall 1010, and the second exit portal 1036 can be formed in the rear wall 1012. A blocking structure 1020, 1022, 1024, 1026 can correspond with each of the portals 1030, 1032, 1034, 1036. In some examples, every portal 1030, 1032, 1034, 1036 can have a corresponding blocking structure 1020, 1022, 1024, 1026. In some examples, only some of the portals 103 may have a corresponding blocking structure 102. For example, only the first entry portal 1030 and the second entry portal 1034 may have a blocking structure 1020, 1024 and/or only the first exit portal 1032 and the second exit portal 1036 may have a blocking structure 1022, 1026. The number and configuration of portals 103 and blocking structures 102 can vary based on desired case of access and control of access. However, for the greatest amount of control and safety, each portal 103 can have a blocking structure 102 so that there are multiple checkpoints while the asset 30 passes through the housing 101.

A dividing wall 210 can be received in the housing 101. The dividing wall 210 can be configured such that each of the one or more through path(s) 1000 are non-linear. For example, as illustrated in FIGS. 2D and 2E where the housing 101 includes two through paths 1002, 1004, the dividing wall 210 can separate the first through path 1002 and the second through path 1004. Additionally, the dividing wall 210 can be configured such that the first through path 1002 between the first entry portal 1030 and the first exit portal 1034 is non-linear, and the second through path 1004 between the second entry portal 1032 and the second exit portal 1036 is non-linear. In some examples where only one through path 1000 is provided, the dividing wall 210 can be formed as part of a side wall of the through path 1000. By having the through path(s) 1000 being non-linear, the asset 30 needs to slow down, and in some examples make a turn, to pass through the housing 101 via the through path 1000.

In at least one example, the dividing wall 210 can include a first portion 2104 coupled with the front wall 1010, a second portion 2100 coupled with the rear wall 1012, and a middle portion 2102 that connects the first portion 2104 and the second portion 2100. In at least one example, the first portion 2104 can extend substantially perpendicular from the front wall 1010. The second portion 2100 can extend substantially perpendicular from the rear wall 1012.

In at least one example, any of the first portion 2104, the second portion 2100, and/or the middle portion 2102 can be substantially linear. In some examples, any of the first portion 2104, the second portion 2100, and/or the middle portion 2102 can be curved such that at least a portion of the dividing wall 210 is curved. In some examples, the dividing wall 210 can include a spline to create a non-linear through path 1000.

The first portion 2104 and the second portion 2100 can be misaligned such that the middle portion 2102 extends at a first divider angle 2104A in relation to the first portion 2104 and a second divider angle 2100A in relation to the second portion 2100. In at least one example, the first divider angle 2104A can be between about 90 degrees and about 150 degrees. In some examples, the second divider angle 2100A can be between about 90 degrees and about 150 degrees.

In at least one example, as the through paths 1000 are non-linear, the portals 103 can be misaligned. For example, the first entry portal 1030 and the first exit portal 1034 are misaligned, and the second entry portal 1032 and the second exit portal 1036 are misaligned. In some examples, the first entry portal 1030 and the first exit portal 1034 may not overlap when viewed perpendicularly through the first entry portal 1030 and/or the first exit portal 1034. In some examples, the second entry portal 1032 and the second exit portal 1036 may not overlap when viewed perpendicularly through the second entry portal 1032 and/or the second exit portal 1036. In some examples, the portals 103 of the through path 1000 may overlap about 50% or less when viewed perpendicularly through the portal 103. In some examples, the portals 103 of the through path 1000 may overlap about 40% or less when viewed perpendicularly through the portal 103. In some examples, the portals 103 of the through path 1000 may overlap about 30% or less when viewed perpendicularly through the portal 103. In some examples, the portals 103 of the through path 1000 may overlap about 20% or less when viewed perpendicularly through the portal 103.

With the non-linear through paths 1000, the access control structure 100 is able to slow down the asset 30 as the asset 30 travels through the through path 1000. By slowing down the asset 30 within the housing 101, the access control structure 100 has more time to prevent unauthorized assets from passing through and gaining access to the zone 14 and/or escape and leave the zone 14.

Referring to FIGS. 1A-2F, in at least one example, to control assets 30 entering the housing 101 and the through path 1000, the control access structure 100 can include a plurality of access readers 200, one or more corresponding to each portal 103 (e.g., the first entry portal 1030, the first exit portal 1034, the second entry portal 1032, and/or the second exit portal 1036). The access readers 200 can be operable to communicate with a badge 250 corresponding to each of the assets 30 that are trying to gain access to the through path 1000 to pass through the housing 101. In at least one example, the access readers 200 can include communication capabilities such as camera, ultra high frequency (UHF), radio frequency ID (RFID), near field communication (NFC), Bluetooth, and/or WiFi to communicate with the badge(s) 250, which can have similar and/or corresponding communication capabilities.

In at least one example, the access readers 200 can be in communication with the controller 52. For the asset 30 to gain access, for example as illustrated in FIG. 2F, the badge 250 can be positioned within a predetermined range of the access reader 200. The controller 52 can then be operable to determine whether the asset 30 associated with that badge 250 is permitted to pass through the housing 101. When the controller 52 determines that the assets 30 are permitted to pass through the housing 101, the controller 52 transitions the blocking structure 102 for the subsequent portal 103 (e.g., the first entry portal 1030, the first exit portal 1034, the second entry portal 1032, and/or the second exit portal 1036) to the pass configuration to permit the asset(s) 30 to pass through the blocking structure 102. When the controller 52 determines that the asset(s) 30 are not permitted to pass through the housing 101, the controller 52 controls the blocking structure 102 for the subsequent portal 103 to remain in the block configuration.

In at least one example, when the blocking structure 102 is transitioned to the pass configuration, an access light 212 corresponding to the blocking structure 102 can change to a pass color. When the blocking structure 102 is in the block configuration, the access light 212 can be a block color. For example, the pass color can be green while the block color can be red. This can inform the asset 30 (or the person accompanying the asset 30) whether they have permission to move through the portal 103 either into the housing 101, into the zone 14, and/or into the outside area 12. This can lessen any delays as people try to open the blocking structure 102 when the blocking structure 102 is in the block configuration.

In at least one example, the access control structure 100 can include one or more internal sensors 206 operable to identify, detect, and/or track passage of the assets 30 (and/or unauthorized assets) while passing through the housing 101 (e.g., through the through path 1000).

In at least one example, the internal sensors 206 can be disposed within the through paths 1000. In some examples, the internal sensors 206 can be disposed external to the through path 1000 but are configured to sense passage of the asset(s) 30 as the asset(s) 30 (and/or unauthorized assets(s)) pass through the through path 1000.

In at least one example, the internal sensors 206 can include UHF, RFID, NFC, Bluetooth, WiFi, camera(s), infrared, and/or any other suitable mechanism to identify, detect, and/or track passage of the assets 30 (and/or unauthorized assets) while passing through the housing 101 (e.g., through the through path 1000). For example, in some examples, the internal sensors 206 can communicate with the badge(s) 250 for the corresponding asset(s) 30 to determine whether the asset 30 is authorized to pass through the through path 1000. In some examples, the internal sensors 206 can include camera(s) to visually track and identify assets 30 and correlate the assets 30 with an authorized list of assets 30 that are permitted to pass through the through path 1000.

In at least one example, the internal sensors 206 can be in communication with the controller 52. The controller 52 can receive data from the internal sensors 206 and determine, based on the internal sensors 206, whether the asset(s) 30 passing through the housing 101 are permitted to pass through the housing 101.

In some examples, the internal sensors 206 can be utilized to determine whether unauthorized asset(s) are trying to pass through the housing 101 to enter the zone 14 and/or leave the zone 14 to the outside area 12. In some examples, the controller 52, based on the internal sensors 206, can be operable to determine that an unauthorized asset is within the housing 101. For example, the controller 52 can be operable to correlate data between the access readers 200 and the internal sensors 206. For example, an unauthorized asset may have tailgated an authorized asset 30. The controller 52 may correlate that only one asset 30 has been granted access into the through path 1000 via the access reader 200, but there are two assets 30 currently in the through path 1000 via the internal sensors 206. Therefore, the access control structure 100 can have multi-factor identification and tracking of location of assets and/or unauthorized assets trying to gain access to and/or leave the zone 14. This can increase safety, boost tracking of assets, and improve the overall workflow of the zone 14.

When the controller 52 determines that an unauthorized asset is in the through path 1000, the controller 52 can control the blocking structure 102 for the subsequent portal 103 to remain in the block configuration to prevent the unauthorized asset to pass through the subsequent portal 103. For example, the unauthorized asset may have entered the housing 101 via the first entry portal 1030. The subsequent portal 103 may then be the first exit portal 1034, and the controller 52 can control the blocking structure 1024 for the first exit portal 1034 to be in the block configuration (e.g., locked, arm down, etc.) so that the unauthorized asset cannot pass exit the housing 101 to an area unauthorized to that unauthorized asset (e.g., zone 14 and/or the outside area 12). In some examples, the controller 52 can control the blocking structure 102 for the portal 103 through which the unauthorized asset utilized to enter into the housing 101 and the through path 1000. For example using the aforementioned example, the controller 52 can control the blocking structure 1020 for the first entry portal 1030 to be in the block configuration so that the unauthorized asset cannot leave the housing 101 in case there is an attempt at a criminal act (e.g., stealing, etc.).

In at least one example, the access control structure 100 can include one or more external sensors 202 in communication with the controller 52. The external sensor(s) 202 can be operable to track one or more assets 30 external of the housing 101 within a range (e.g., within a distance across a street, alternately within 100 yards, alternately within 80 yards, etc.). For example, the external sensor(s) 202 can include UHF, RFID, NFC, Bluetooth, WiFi, camera(s), floodlight(s), infrared, and/or any other suitable mechanism to identify, detect, and/or track passage of the assets 30 (and/or unauthorized assets) while outside and/or near the housing 101. Accordingly, the external sensors 202 may detect that an asset 30 (either authorized and/or unauthorized) may be approaching or passing near the housing 101. The controller 52 can then have time to identify the asset 30 as being authorized or unauthorized before the asset 30 approaches. In some examples, the controller 52 can then create contact with the necessary authority or authorities (e.g., police, management, etc.) before the asset 30 is in the housing 101. In some examples, the controller 52, utilizing the external sensor(s) 202, can determine the location and/or the travel path of the asset 30. For example, if an unauthorized asset 30 (and/or a misplaced asset) has gained access within the zone 14, the controller 52 may determine that the unauthorized asset 30 has passed by the housing 101 and send an alert to the necessary authority or authorities about the unauthorized asset's 30 whereabouts and/or travel path.

In at least one example, the access control structure 100 can include one or more signal transmitters 110 in communication with the controller 52. The controller 52 can be operable to transmit and/or receive, via the signal transmitter(s) 110, data regarding the asset(s) 30 passing through and/or near the housing 101 and/or passing through and/or near the zone 14. In at least one example, the signal transmitter 110 can include an Internet transmitter 1100. The Internet transmitter 1100 can be operable to communicate with one or more satellites to provide high-speed internet access to users in and/or around the zone 14. Accordingly, the access control structure(s) 100 for the access control system 10 can provide internet connectivity within the zone 14. In at least one example, the signal transmitter 110 can include a crosslink transmitter 1102. The crosslink transmitter 1102 can be operable to communicate with other crosslink transmitters 1102, for example with other access control structures 100.

In at least one example, the signal transmitter(s) 110 can be disposed on a retractable antenna mast 108 coupled with the housing 101. For example, referring to FIGS. 2A and 2B, the retractable antenna mast 108 is coupled with the top surface 1018 of the housing 101. FIG. 2A illustrates the retractable antenna mast 108 in a retracted configuration, and FIG. 2B illustrates the retractable antenna mast 108 in an extended configuration. The retractable antenna mast 108 allows for the access control structure 100 to be easily transported when the retractable antenna mast 108 is in the retracted configuration, without needing to remove the mast 108.

In at least one example, the access control structure 100 can include a drone dock 106 coupled with the housing 101. For example, as shown in FIGS. 2B and 2C, the drone dock 106 can be coupled with the top surface 1018 of the housing 101. The drone dock 106 can be operable to store and/or receive one or more drones 1060 deployable around the zone 14.

In at least one example, referring to FIGS. 2D and 2E, the access control structure 100 can include a power source 208 coupled with the housing 101. In some examples, the access control structure 100 can include a plurality of power sources 208 depending on the amount of power needed to run the access control structure 100. In at least one example, the power source(s) 208 can be disposed within the housing 101. In some examples, the power source(s) 208 can be disposed outside of the housing 101. The power source(s) 208 can include a battery operable to store power. By having the power source(s) 208 as part of the access control structure 100, the access control structure 100 is self-contained and self-powered.

In at least one example, referring to FIGS. 2A and 2B, the access control structure 100 can include one or more solar panels 104 coupled with the housing 101. In at least one example, the solar panels 104 can be coupled with the top surface 1018 of the housing 101. The solar panels 104 can be operable to provide power to the power source(s) 208. FIG. 2A illustrates the solar panels 104 in a stored configuration, and FIG. 2B illustrates the solar panels 104 in an open configuration.

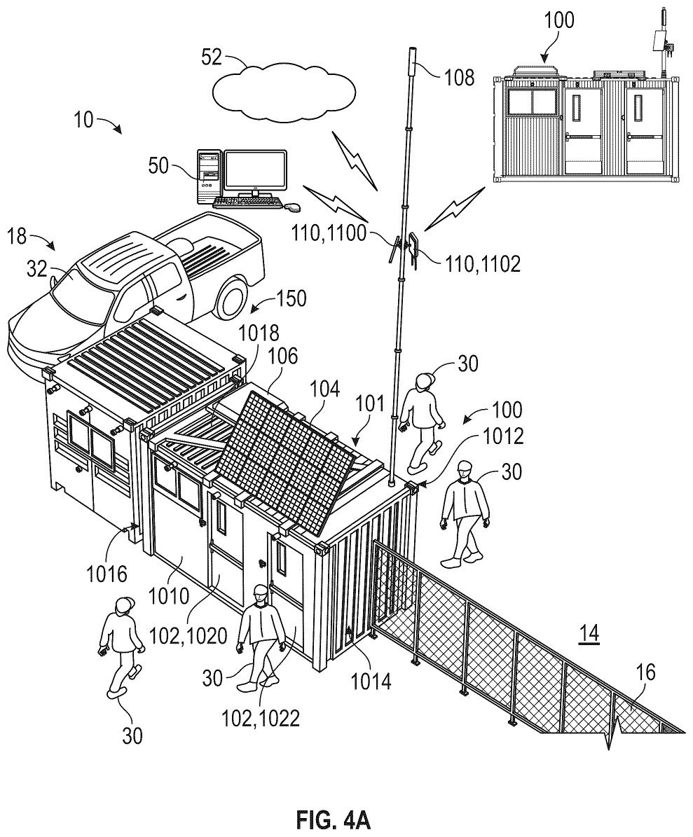

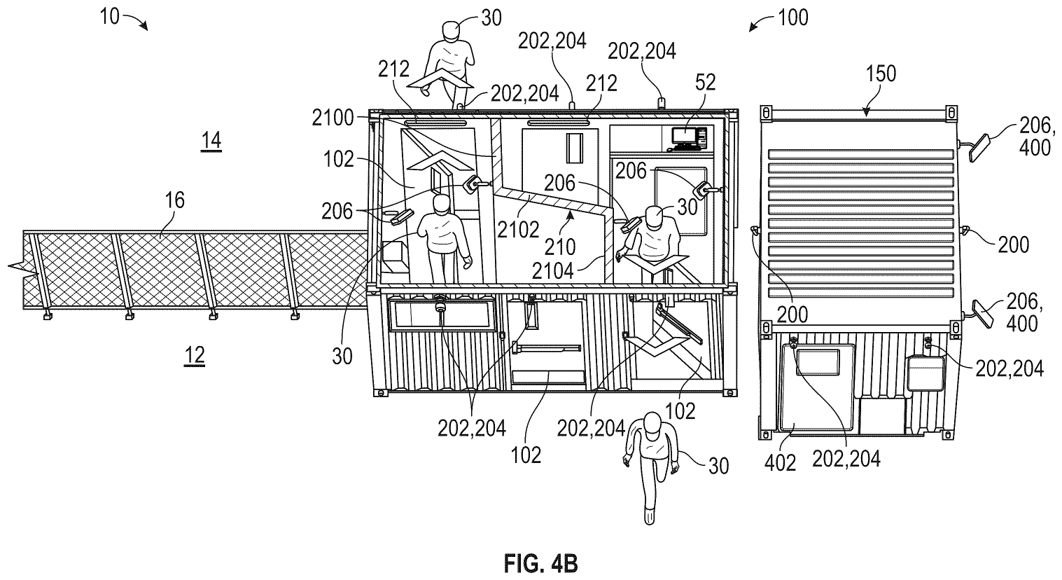

Referring to FIGS. 4A and 4B, in some examples, the access control system 10 can include a guard component 150 which is operable to monitor and/or control an open portion 18 such as a gate, a drive through, etc. For example, a vehicle 32 may be able to drive through the open portion 18, as the vehicle 32 cannot pass through the housing 101 of the access control structure 100. The vehicle 32 may carry or include one or more asset(s) 30. In some examples, the guard component 150 can include a guard shack, for example with a door 402 through which a person can enter the guard shack. In some examples, the guard component 150 can be an extension and/or coupled with the housing 101 of the access control structure 100. The guard component 150 can include one or more internal sensors 206, 400 operable to identify, detect, and/or track the asset 30 (e.g., vehicle 32) as it passes by the guard component 150. The internal sensors 400 for the guard component 150 can be coupled to the outside of the guard component 150 (e.g., the outside of the guard shack and/or outside of the housing 101). However, it is pointed towards the inside of the path through which the vehicle 32 must pass to enter and/or exit the zone 14. In some examples, the guard component 150 can include one or more access readers 200 that are operable to communicate with a corresponding badge 250 of the asset 30, 32. The access reader(s) 200 can be coupled to the outside of the guard component 150 (e.g., the outside of the guard shack and/or outside of the housing 101). However, the access reader 200 can be pointed towards the inside of the path through which the vehicle 32 (with asset(s) 30) must pass to enter and/or exit the zone 14. In some examples, the guard component 150 can include one or more external sensors 202, 204 operable to identify, detect, and/or track asset(s) 30 approaching the guard component 150.

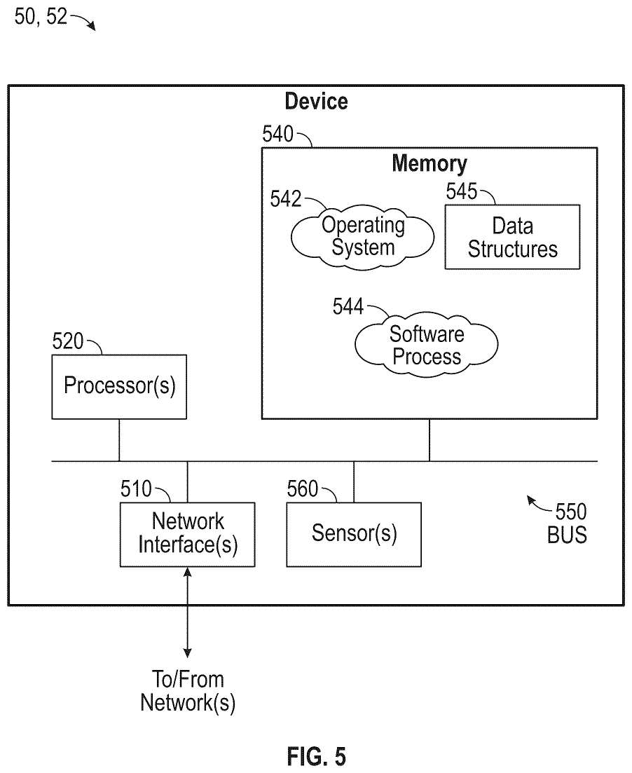

FIG. 5 is a block diagram of an exemplary controller 50, 52. Controller 50, 52 is configured to perform processing of data and communicate with the components, for example as illustrated in FIGS. 1A-4B. In operation, controller 50, 52 communicates with one or more of the above-discussed components and may also be configured to communication with remote devices/systems.

As shown, controller 50, 52 includes hardware and software components such as network interfaces 510, at least one processor 520, sensors 560 and a memory 540 interconnected by a system bus 550. Network interface(s) 510 can include mechanical, electrical, and signaling circuitry for communicating data over communication links, which may include wired or wireless communication links. Network interfaces 510 are configured to transmit and/or receive data using a variety of different communication protocols, as will be understood by those skilled in the art.

Processor 520 represents a digital signal processor (e.g., a microprocessor, a microcontrol system, or a fixed-logic processor, etc.) configured to execute instructions or logic to perform tasks in a jobsite environment. Processor 520 may include a general purpose processor, special-purpose processor (where software instructions are incorporated into the processor), a state machine, application specific integrated circuit (ASIC), a programmable gate array (PGA) including a field PGA, an individual component, a distributed group of processors, and the like. Processor 520 typically operates in conjunction with shared or dedicated hardware, including but not limited to, hardware capable of executing software and hardware. For example, processor 520 may include elements or logic adapted to execute software programs and manipulate data structures 545, which may reside in memory 540.

Sensors 560 typically operate in conjunction with processor 520 to perform measurements, and can include special-purpose processors, detectors, transmitters, receivers, and the like. In this fashion, sensors 560 may include hardware/software for generating, transmitting, receiving, detection, logging, and/or sampling varying parameters.

Memory 540 comprises a plurality of storage locations that are addressable by processor 520 for storing software programs and data structures 545 associated with the embodiments described herein. An operating system 542, portions of which may be typically resident in memory 540 and executed by processor 520, functionally organizes the device by, inter alia, invoking operations in support of software processes and/or services 544 executing on controller 50, 52. These software processes and/or services 544 may perform processing of data and communication with controller 50, 52, as described herein. Note that while process/service 544 is shown in centralized memory 540, some examples provide for these processes/services to be operated in a distributed computing network.

It will be apparent to those skilled in the art that other processor and memory types, including various computer-readable media, may be used to store and execute program instructions pertaining to the processes and components described herein. Also, while the description illustrates various processes, it is expressly contemplated that various processes may be embodied as modules having portions of the process/service 544 encoded thereon. In this fashion, the program modules may be encoded in one or more tangible computer readable storage media for execution, such as with fixed logic or programmable logic (e.g., software/computer instructions executed by a processor, and any processor may be a programmable processor, programmable digital logic such as field programmable gate arrays or an ASIC that comprises fixed digital logic. In general, any process logic may be embodied in processor 520 or computer readable medium encoded with instructions for execution by processor 520 that, when executed by the processor, are operable to cause the processor to perform the functions described herein.

Additionally, the controller 50, 52 can apply machine learning, such as a neural network or sequential logistic regression and the like, to determine relationships between the training and the employee. For example, a deep neural network may be trained in advance to capture the complex relationship between the movement of the personnel and/or the equipment and the tasks being completed at the jobsite. This neural net can then be deployed in the determination of access and/or tasks to be completed by the personnel. As such, the determination of whether the personnel can be allowed access in certain areas or determine what activity the personnel is performing in relation to the movement of personnel and/or equipment.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. An access control structure operable to control access to a zone, the access control structure comprising:
a housing forming a first through path and a second through path, wherein the first through path includes a first entry portal and a first exit portal, and wherein the second through path includes a second entry portal and a second exit portal;
a dividing wall received in the housing, the dividing wall separating the first through path and the second through path, the dividing wall being configured such that the first through path between the first entry portal and the first exit portal is non-linear and the second through path between the second entry portal and the second exit portal is non-linear.

2. The access control structure of claim 1, wherein the first entry portal and the first exit portal are misaligned, and wherein the second entry portal and the second exit portal are misaligned.

3. The access control structure of claim 1, wherein the first entry portal and the second entry portal are formed in a front wall of the housing, and wherein the first exit portal and the second exit portal are formed in a rear wall of the housing opposite the front wall.

4. The access control structure of claim 3, wherein the dividing wall includes a first portion coupled with the front wall, a second portion coupled with the rear wall, and a middle portion that connects the first portion and the second portion; wherein the first portion and the second portion are misaligned such that the middle portion extends at a first divider angle in relation to the first portion and a second divider angle in relation to the second portion.

5. The access control structure of claim 4, wherein the first divider angle and/or the second divider angle is between about 90 degrees and about 150 degrees.

6. The access control structure of claim 4, wherein the first portion extends substantially perpendicular from the front wall, and the second portion extends substantially perpendicular from the rear wall.

7. The access control structure of claim 1, wherein the dividing wall includes a spline.

8. The access control structure of claim 1, wherein at least a portion of the dividing wall is curved.

9. The access control structure of claim 1, wherein the first entry portal, the first exit portal, the second entry portal, and the second exit portal each include a blocking structure that is operable to transition between a block configuration to prevent passage therethrough and a pass configuration to permit passage therethrough, wherein a controller in communication with each of the blocking structures is operable to transition the blocking structure between the block configuration and the pass configuration.

10. The access control structure of claim 9, further comprising: a plurality of access readers corresponding to each of the first entry portal, the first exit portal, the second entry portal, and the second exit portal, wherein the plurality of access readers are operable to communicate with a badge corresponding to each of one or more assets that are passing through the housing.

11. The access control structure of claim 10, wherein the plurality of access readers is in communication with the controller;
wherein when the badge is positioned within a predetermined range of any the plurality of access readers, the controller is operable to determine whether the one or more assets associated with the badge is permitted to pass through the housing;
wherein when the controller determines that the one or more assets are permitted to pass through the housing, the controller transitions the blocking structure for the subsequent portal of the first entry portal, the first exit portal, the second entry portal, and/or the second exit portal to the pass configuration to permit the one or more assets to pass through the blocking structure;
wherein when the controller determines that the one or more assets are not permitted to pass through the housing, the controller controls the blocking structure for the subsequent portal of the first entry portal, the first exit portal, the second entry portal, and/or the second exit portal to remain in the block configuration.

12. The access control structure of claim 11, wherein when the blocking structure is transitioned to the pass configuration, an access light corresponding to the blocking structure changes to a pass color, wherein when the blocking structure is in the block configuration, the access light is a block color.

13. The access control structure of claim 11, further comprising one or more internal sensors operable to track passage of the one or more assets while passing through the housing.

14. The access control structure of claim 13, wherein the one or more internal sensors are operable to communicate with the badge associated with each of the one or more assets.

15. The access control structure of claim 14, wherein the controller, based on the one or more internal sensors, is operable to determine that an unauthorized asset is within the housing, and wherein the controller controls the blocking structure for the subsequent portal of the first entry portal, the first exit portal, the second entry portal, and/or the second exit portal to remain in the block configuration to prevent the unauthorized asset to pass through the subsequent portal.

16. The access control structure of claim 11, further comprising one or more external sensors in communication with the controller, wherein the one or more external sensors are operable to track the one or more assets external of the housing within a range.

17. The access control structure of claim 10, further comprising one or more signal transmitters in communication with the controller, wherein the controller is operable to transmit and/or receive, via the one or more signal transmitters, data regarding the one or more assets passing through the housing and/or the zone.

18. The access control structure of claim 1, further comprising a drone dock coupled with the housing, the drone dock operable to store and/or receive one or more drones deployable around the zone.

19. An access control system for a zone, the access control system comprising:
a plurality of access control structures, each of the plurality of access control structures including:
a housing forming a first through path and a second through path, wherein the first through path includes a first entry portal and a first exit portal, and wherein the second through path includes a second entry portal and a second exit portal;
a dividing wall received in the housing, the dividing wall separating the first through path and the second through path, the dividing wall being configured such that the first through path between the first entry portal and the first exit portal is non-linear and the second through path between the second entry portal and the second exit portal is non-linear; and
a blockade connecting each of the plurality of the access control structures such that the plurality of the access control structures and the blockade form a perimeter around the zone.

20. The access control system of claim 19, wherein the plurality of access control structures is operable to communicate with each other so that data regarding movement of the one or more assets within the zone are tracked.
